(19) United States
(12) Patent Application Publication
(10) Pub. No.: US 2015/0092689 A1
(43) Pub. Date: Apr. 2, 2015

(54) SCHEDULING METHOD AND APPARATUS FOR DEVICE TO DEVICE COMMUNICATION

(71) Applicant: Electronics and Telecommunications Research Institute, Daejeon (KR)

(72) Inventors: Young Jo Ko, Daejeon (KR); Jae Young Ahn, Daejeon (KR); Tae Gyun Noh, Daejeon (KR); Bang Won Seo, Daejeon (KR)

(21) Appl. No.: 14/389,875

(22) PCT Filed: Apr. 29, 2013
(86) PCT No.: PCT/KR2013/003695

§ 371 Date: Oct. 1, 2014

(30) Foreign Application Priority Data
Apr. 30, 2012 (KR) 10-2012-0045856

(51) Int. Cl. H04W 72/04; H04L 1/18; H04L 5/00; H04W 76/02

(52) U.S. Cl. CPC H04W 72/0406; H04W 76/023; H04L 1/1861; H04L 5/0048
USPC 370/329

(57) ABSTRACT

A scheduling method and apparatus for a device to device communication are disclosed. The device to device communication method comprises the steps of: transmitting first data to a second terminal through a pre-assigned first sub-frame; and receiving a response corresponding to the first data and second data from the second terminal through a pre-assigned second sub-frame. Therefore, the present invention can prevent a collision of transmitted and received data between the devices.

### TECHNICAL FIELD

The present invention relates to scheduling technology, more particularly, to scheduling methods and apparatus for preventing collision between device-to-device (D2D) communication (D2D) and cellular communication.

### BACKGROUND ART

In a cellular communication environment, a conventional method by which terminals transmit and receive data is using a base station. That is, if a first terminal has data for transmitting to a second terminal, the first terminal transmits the data to a first base station serving the first terminal. The first base station transmits data received from the first terminal to a second base station serving a second terminal. Finally, the second base station transmits the data received from the first base station to the second terminal. Here, the first base station and the second base station may be identical or different from one another.

On the other hand, device-to-device communication (D2D) means terminals directly communicate without going through the base station. That is, the first terminal can transmit and receive data by directly communicating with the second terminal without communicating through the base station.

In an environment in which both cellular communication and the device-to-device communication are supported, the cellular communication and the device-to-device communication can occur simultaneously within the same subframe. There may be a problem transmitting data because of such a collision.

### DISCLOSURE

### Technical Problem

The present invention is directed to providing a communication method of a terminal for preventing collision between cellular communication and device-to-device communication through scheduling.

Further, the present invention is directed to providing a terminal for device-to-device communication which avoids collision between cellular communication and device-to-device communication through scheduling.

### Technical Solution

One aspect of the present invention provides a method, performed by a first terminal, for direct communication between the first terminal and a second terminal, including transmitting first data to the second terminal through a previously allocated first subframe, and receiving a response to the first data and second data from the second terminal through a previously allocated second subframe.

The method further includes transmitting a response to the second data and third data to the second terminal through a subframe corresponding to a next period of the first subframe.

The response to the first data may be a HARQ (hybrid automatic repeat-request) response for the first data.

The first data may be control information.

The third data may be retransmission data for the first data.

A period of the first subframe may be a multiple of a subframe period decided by a HARQ method for cellular communication.

The first subframe may be allocated by a base station by a semi-persistent scheduling (SPS) method.

Another aspect of the present invention provides a method, performed by a first terminal, for direct communication between the first terminal and a second terminal, including transmitting data to the second terminal through a first subframe which is allocated by a semi-persistent scheduling (SPS) method, and receiving a response to the data from the second terminal through a previously allocated second subframe.

The method further includes retransmitting the data to the second terminal through a subframe corresponding to a next period of the first subframe.

A period of the first subframe may be a multiple of a subframe period decided by a HARQ method for cellular communication.

The response to the data may be a HARQ (hybrid automatic repeat-request) response for the data.

Still another aspect of the present invention provides a method, performed by a first terminal, for direct communication between the first terminal and a second terminal, including transmitting a sounding reference signal (SRS) to the second terminal through the last symbol of a previously allocated first subframe, and receiving data at the second terminal through a second subframe which is located next to the first subframe.

A period of the first subframe may be a multiple of a subframe period decided by a HARQ method for cellular communication.

In transmitting the sounding reference signal (SRS) to the second terminal through the last symbol of the previously allocated first subframe, if there is data transmitted through the second subframe, the sounding reference signal may be transmitted to the second terminal through the last symbol of the first subframe.

In transmitting the sounding reference signal (SRS) to the second terminal through the last symbol of the previously allocated first subframe, if the second subframe has been allocated by a base station by a semi-persistent scheduling (SPS) method, the sounding reference signal may be transmitted to the second terminal through the last symbol of the first subframe.

In transmitting the sounding reference signal (SRS) to the second terminal through the last symbol of the previously allocated first subframe, if the second subframe has been allocated by a base station by a semi-persistent scheduling (SPS) method, and there is data to be transmitted through the second subframe, the sounding reference signal may be transmitted to the second terminal through the last symbol of the first subframe.

In transmitting the sounding reference signal (SRS) to the second terminal through the last symbol of the previously allocated first subframe, if the data corresponds to an initial transmission, which is transmitted based on a HARQ method for direct communication between the first terminal and the second terminal, the sounding reference signal may be transmitted to the second terminal through the last symbol of the first subframe.

Yet another aspect of the present invention provides a method, performed by a first terminal, for direct communication between the first terminal and a second terminal, including mapping data to a previously allocated first subframe, mapping a sounding reference signal to the last symbol of a first subframe, and transmitting the first subframe, to which the data and the sounding reference signal has been mapped, to the second terminal.

A period of the first subframe may be a multiple of a subframe period decided by a HARQ method of cellular communication.

In mapping the sounding reference signal to the last symbol of a first subframe, if the data corresponds to an initial transmission, which is transmitted based on a HARQ method for direct communication between the first terminal and the second terminal, an operation of mapping the sounding reference signal to the last symbol of the first subframe may be performed.

### Advantageous Effects

According to the present invention, through scheduling, cellular communication and direct communication between terminals are prevented from occurring simultaneously in the same subframe. Accordingly, a collision in data transmission and reception between terminals can be prevented.

### DESCRIPTION OF DRAWINGS

FIG. 1 is a conceptual diagram showing one-way information transmission in device-to-device communication.

FIG. 2 is a conceptual diagram showing a HARQ process for one-way information transmission in device-to-device communication according to one exemplary embodiment of the present invention.

FIG. 3 is a conceptual diagram showing a HARQ process for one-way information transmission in device-to-device communication according to another exemplary embodiment of the present invention.

FIG. 4 is a conceptual diagram showing two-way information transmission in device-to-device communication.

FIG. 5 is a conceptual diagram showing a HARQ process for two-way information transmission in device-to-device communication according to one exemplary embodiment of the present invention.

FIG. 6 is a conceptual diagram showing a HARQ process for two-way information transmission in device-to-device communication according to another exemplary embodiment of the present invention.

FIG. 7 is a conceptual diagram showing a HARQ process for transmission and reception switching in device-to-device communication according to one exemplary embodiment of the present invention.

FIG. 8 is a flowchart showing a communication method of a terminal according to a first exemplary embodiment of the present invention.

FIG. 9 is a conceptual diagram showing resource allocation by semi-persistent scheduling without transmission and reception switching according to an exemplary embodiment of the present invention.

FIG. 10 is a conceptual diagram showing a HARQ process for resource allocation by semi-persistent scheduling according to an exemplary embodiment of the present invention.

FIG. 11 is a conceptual diagram showing resource allocation by semi-persistent scheduling in device-to-device communication according to an exemplary embodiment of the present invention.

FIG. 12 is a conceptual diagram showing a HARQ process for resource allocation by semi-persistent scheduling according to one exemplary embodiment of the present invention.

FIG. 13 is a conceptual diagram showing a HARQ process for resource allocation by semi-persistent scheduling according to another exemplary embodiment of the present invention.

FIG. 14 is a flowchart showing a communication method of a terminal according to a second exemplary embodiment of the present invention.

FIG. 15 is a conceptual diagram showing sounding reference signal transmission according to one exemplary embodiment of the present invention.

FIG. 16 is a conceptual diagram showing sounding reference signal transmission according to another exemplary embodiment of the present invention.

FIG. 17 is a conceptual diagram showing periodic resource allocation and sounding reference signal transmission according to one exemplary embodiment of the present invention.

FIG. 18 is a conceptual diagram showing periodic resource allocation and sounding reference signal transmission according to another exemplary embodiment of the present invention.

FIG. 19 is a conceptual diagram showing aperiodic resource allocation and sounding reference signal transmission according to an exemplary embodiment of the present invention.

FIG. 20 is a conceptual diagram showing resource allocation by semi-persistent scheduling according to one exemplary embodiment of the present invention.

FIG. 21 is a conceptual diagram showing resource allocation by semi-persistent scheduling according to another exemplary embodiment of the present invention.

FIG. 22 is a conceptual diagram showing resource allocation according to aperiodic semi-persistent scheduling according to an exemplary embodiment of the present invention.

FIG. 23 is a conceptual diagram showing retransmission and sounding reference signal transmission and reception according to an exemplary embodiment of the present invention.

FIG. 24 is a flowchart showing a communication method of a terminal according to a third exemplary embodiment of the present invention.

FIG. 25 is a conceptual diagram showing periodic resource allocation and sounding reference signal transmission according to one exemplary embodiment of the present invention.

FIG. 26 is a conceptual diagram showing periodic resource allocation and sounding reference signal transmission according to another exemplary embodiment of the present invention.

FIG. 27 is a conceptual diagram showing aperiodic resource allocation and sounding reference signal transmission according to an exemplary embodiment of the present invention.

FIG. 28 is a conceptual diagram showing resource allocation by semi-persistent scheduling according to one exemplary embodiment of the present invention.

FIG. 29 is a conceptual diagram showing resource allocation by semi-persistent scheduling according to another exemplary embodiment of the present invention.

FIG. 30 is a conceptual diagram showing sounding reference signal transmission by semi-persistent scheduling according to an exemplary embodiment of the present invention.

FIG. 31 is a conceptual diagram showing sounding reference signal transmission according to aperiodic semi-persistent scheduling according to an exemplary embodiment of the present invention.

FIG. 32 is a conceptual diagram showing retransmission and sounding reference signal transmission according to an exemplary embodiment of the present invention.

FIG. 33 is a flowchart showing a communication method of a terminal according to a fourth exemplary embodiment of the present invention.

FIG. 34 is a conceptual diagram showing C-PUSCH transmission and sounding reference signal reception within the same subframe according to an exemplary embodiment of the present invention.

FIG. 35 is a conceptual diagram showing C-PUSCH transmission and sounding reference signal reception within different subframes according to an exemplary embodiment of the present invention.

### MODES OF THE INVENTION

Since the present invention may have diverse modified embodiments, preferred embodiments are illustrated in the drawings and described in the detailed description of the invention.

However, it should be understood that these particular embodiments are not intended to limit the scope of the present disclosure to specific forms. On the contrary, the present disclosure is meant to cover all modification, similarities, and alternatives which are included within the spirit and scope of the appended claims.

Relational terms such as first, second, and the like may be used for describing various elements, but the elements should not be limited by the terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In the present invention, the technical terms are used only for explaining a specific exemplary embodiment while not limiting the present disclosure. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless specific definitions are given, terms used in the present disclosure should be interpreted as having the same meanings that are commonly attributed to them in the art.

Embodiments of the present invention will be described below in more detail with reference to the accompanying drawings. Elements that appear in more than one drawing or are mentioned in more than one place in the detailed description will be denoted by the same respective reference numerals throughout the application.

In this specification, for example, a network may include wireless Internet such as a WiFi (Wireless Fidelity), portable Internet such as a WiBro (Wireless Broadband Internet) or WiMax (Wireless Broadband Internet), a 2G mobile radio communication network such as a GSM (Global System for Mobile communication) network or a CDMA (Code Division Multiple Access) network, a 3G mobile radio communication network such as a WCDMA (Wideband Code Division Multiple Access) network or a CDMA2000 network, a 3.5G mobile radio communication network such as a HSDPA (High Speed Downlink Packet Access) network or a HSUPA (High Speed Uplink Packet Access) network, and a 4G mobile radio communication network such as an LTE (Long Term Evolution) network or an LTE-Advanced network, and so on.

In this specification, a terminal may be a mobile station, a mobile terminal, a subscriber station, a portable subscriber station, user equipment, an access terminal, and so on, and may include all or some functions of the mobile station, the mobile terminal, the subscriber station, the portable subscriber station, the user equipment, the access terminal, and so on.

Here, a desktop computer, a laptop computer, a tablet PC, a wireless phone, a mobile phone, a smart phone, an e-book reader, a PMP (portable multimedia player, a portable game machine, a navigation apparatus, a digital camera, a DMB (Digital Multimedia Broadcasting) player, a digital audio recorder, a digital audio player, a digital picture recorder, a digital picture player, a digital video recorder, a digital video player), and so on, which can communicate, may be used as the terminal.

In this specification, the base station may be an access point, a wireless radio access station, a node B, an evolved node B, a base transceiver station, a mobile multihop relay-BS, and so on, and may include all or some functions of the access point, the wireless radio access station, the node B, the evolved node B, the base transceiver station, the mobile multihop relay0-BS, and so on.

In a cellular communication environment, a conventional method by which terminals transmit and receive data is a method of using the base station. That is, if a first terminal has data for transmitting to a second terminal, the first terminal transmits the data to a first base station corresponding to the first terminal. The first base station transmits data receiving from the first terminal to a second base station corresponding to the second terminal. Finally, the second base station transmits the data received from the first base station to the second terminal. Here, the first base station and the second base station may be identical or different from each other.

In the cellular communication environment, the terminals communicating with the base station may perform device-to-device communication depending on a situation. Communication of these terminals may be switched to communication through the base station, or direct communication between terminals without communicating through the base station, depending on a situation.

Device-to-device communication scenarios may largely be classified into three types. That is, (1) a scenario in which device-to-device (D2D) communication between terminals within the same cell is allowed, (2) if a base station manages a plurality of cells, a scenario in which device-to-device (D2D) communication between terminals belonging to the same base station is allowed, (3) a scenario in which device-to-device (D2D) communication between arbitrary terminals is allowed regardless of the cell and the base station with which the terminals are affiliated.

Duplexing methods of a conventional cellular communication system may be classified into a frequency division duplexing (FDD) method and a time division duplexing (TDD) method. In the frequency division duplexing method, a frequency band used for the terminal to transmit data to the base station, (hereinafter, it may be called an “uplink band”), and a frequency band used for the base station to transmit data to the terminal (hereinafter, it may be called a “downlink band”), may be different from each other.

On the other hand, in the time division duplexing (TDD) method, the uplink band and the downlink band may use the same frequency band. In the time division duplexing (TDD) method, a subframe used for the terminal to transmit data to the base station may be called an uplink subframe, and a subframe used for the base station to transmit data to the terminal may be called a downlink subframe.

Three main methods may be used for applying the device-to-device (D2D) communication to the frequency division duplexing (FDD) method of cellular communication. That is, there may be (1) a method of using only the uplink band for performing the device-to-device (D2D) communication, (2) a method of using only the downlink band for performing the device-to-device (D2D) communication, (3) a method of using both the uplink band and the downlink band for performing the device-to-device (D2D) communication.

Three main methods may be used for applying the device-to-device (D2D) communication to the time division duplexing (TDD) method of cellular communication. That is, there may be (1) a method of using only the uplink subframe for performing the device-to-device (D2D) communication. (2) a method of using only the downlink subframe for performing the device-to-device (D2D) communication, (3) a method of using both the uplink subframe and the downlink subframe for performing the device-to-device (D2D) communication.

In a system that supports both LTE (long term evolution) cellular communication and the D2D communication, a channel for the LTE cellular communication and a channel for device-to-device (D2D) communication may need to be differentiated from each other. As shown in the following Table 1, this may be accomplished by adding ‘C’ in front of a physical channel used for the LTE cellular communication, and adding ‘D2D’ in front of a physical channel used for the D2D communication. In the case of device-to-device (D2D) communication, since transmission and reception are distinguished from each other for the same physical channel, transmission may be represented by adding ‘Tx’ behind the physical channel, and reception may be represented by adding ‘Rx’ behind the physical channel.

TABLE 1

| Downlink frequency band | | Uplink frequency band | |
|---|---|---|---|
| Cellular | | Cellular | |
| communication | D2D | communication | D2D |
| C-PCFICH | D2D-PDCCH | C-PUSCH | D2D-PUSCH Tx |
| C-PDCCH | D2D-PHICH | C-PUCCH | D2D-PUSCH Rx |
| C-PHICH | | C-SRS | D2D-PUCCH Tx |
| C-PDSCH | | C-PRACH | D2D-PUCCH Rx |
| | | | D2D-SRS Tx |
| | | | D2D-SRS Rx |

Here, PCFICH may mean a physical control format indicator channel, PDCCH may mean a physical downlink control channel, PHICH may mean a physical hybrid-ARQ indicator channel, PDSCH may mean a physical downlink shared channel, PUSCH may mean a physical uplink shared channel, and PUCCH may mean a physical uplink control channel.

‘D2D Tx’ may mean transmission of at least one of data and control information for device-to-device (D2D) communication, and ‘D2D Rx’ may mean reception of at least one of data and control information for device-to-device (D2D) communication. However, other signals (for example, a sounding reference signal (SRS), etc.) which are needed for device-to-device (D2D) communication may not be included in ‘D2D Tx’ or ‘D2D Rx’.

In the system that supports both cellular communication and D2D communication, a collision may occur where the cellular communication and the device-to-device (D2D) communication are performed simultaneously within the same subframe. Further, a collision may occur where ‘D2D Tx’ and ‘D2D Rx’ are performed simultaneously within the same subframe. These collisions may be largely classified as (1) a collision between the cellular uplink transmission and ‘D2D Rx’, (2) a collision between ‘D2D Tx’ and ‘D2D Rx’, and (3) a collision between the cellular uplink transmission and ‘D2D Tx’.

Among these collisions, collisions between transmission and reception (that is, collision between cellular uplink transmission and ‘D2D Rx’, and collision between ‘D2D Tx’ and ‘D2D Rx’) can be avoided by applying scheduling restrictions.

In LTE cellular uplink transmission, a synchronous HARQ (hybrid automatic repeat request) method in which a round trip time (RTT) may be 8 ms (that is, 8-subframe interval) may be used. Accordingly, in order to prevent collision with the HARQ process for the cellular uplink, it may be desirable that HARQ processes for device-to-device (D2D) communication use synchronous HARQ processes whose RTT may be 8×n ms (n is a positive integer).

ACK/NACK transmission for D2D-PUSCH Rx in subframe n (D2D-HARQ ACK Tx) may occur in subframe n+k (k is a positive integer).

Based on this, sets may be defined as below.
C_{PUSCH-Tx}={C-PUSCH subframe numbers}
D_{PUSCH-Rx}={D2D-PUSCH Rx subframe numbers}
D_{HARQ-ACK-Tx}={(D2D-PUSCH Rx subframe numbers+k) mod 8}
D_{PUSCH-Tx}={D2D-PUSCH Tx subframe numbers}
D_{HARQ-ACK-Rx}={(D2D-PUSCH Tx subframe numbers+k) mod 8}
E_{PDSCH-Rx}={C-PDSCH subframe numbers}
C_{HARQ-ACK-Tx}={(C-PDSCH subframe numbers+4} mod 8}

Table 2 in the below represents scheduling restrictions for various collisions using the above sets, and explains the meaning of each of the scheduling restrictions. Here, TB may mean a transport block.

TABLE 2

| | Scheduling | | |
|---|---|---|---|
| Order | Restriction | Meaning | Other |
| 0 | D_{PUSCH-Tx} ∩ | prohibition of simultaneous | |
| | D_{PUSCH-Rx} = ∘ | Tx/Rx occurrence | |
| | (null set) | | |
| 1 | D_{PUSCH-Tx} ∩ | prohibition of simultaneous | |
| | D_{HARQ-ACK-Rx} = ∘ | Tx/Rx occurrence | |
| 2 | D_{PUSCH-Rx} ∩ | prohibition of simultaneous | |
| | D_{HARQ-ACK-Tx} = ∘ | Tx/Rx occurrence | |
| 3 | C_{PUSCH-Tx} ∩ | prohibition of simultaneous | |
| | D_{PUSCH-Rx} = ∘ | Tx/Rx occurrence | |
| 4 | C_{PUSCH-Tx} ∩ | prohibition of simultaneous | |
| | D_{HARQ-ACK-Rx} = ∘ | Tx/Rx occurrence | |
| 5 | C_{PUSCH-Tx} ∩ | prohibition of simultaneous | |
| | D_{PUSCH-TX} = ∘ | transmission of cellular | |
| | | TB and D2D TB in the | |
| | | same uplink subframe | |
| 6 | C_{PUSCH-Tx} ∩ | prohibition of simultaneous | |
| | D_{HARQ-ACK-Tx} = ∘ | cellular and D2D | |
| | | transmission in the same | |
| | | uplink subframe | |
| 7 | C_{HARQ-ACK-Tx} ∩ | prohibition of simultaneous | |
| | D_{PUSCH-Rx} = ∘ | Tx/Rx occurrence | |
| 8 | C_{HARQ-ACK-Tx} ∩ | prohibition of simultaneous | |
| | D_{HARQ-ACK-Rx} = ∘ | Tx/Rx occurrence | |
| 9 | C_{HARQ-ACK-Tx} ∩ | prohibition of simultaneous | |
| | D_{PUSCH-Tx} = ∘ | cellular and D2D | |
| | | transmission in the same | |
| | | uplink subframe | |
| 10 | C_{HARQ-ACK-Tx} ∩ | prohibition of simultaneous | |
| | D_{HARQ-ACK-Tx} = ∘ | cellular and D2D | |
| | | transmission in the same | |
| | | uplink subframe | |
| 11 | E_{PDSCH-Rx} ∩ | Prohibition of simultaneous | Depending on |
| | D_{PUSCH-Rx} = ∘ | reception of cellular | terminal |
| | | TB and D2D TB in the | capability, |
| | | same uplink subframe | decision of |
| | | | prohibition or |
| | | | allowance can |
| | | | be made |

As a resource allocation method for device-to-device (D2D) communication a periodic resource allocation in units of HARQ process will be explained in detail in the following. The periodic resource allocation in HARQ process units may be classified into resource allocation without data transmission/reception switching and resource allocation with data transmission/reception switching. In the case of resource allocation without data transmission/reception switching, the resource which is allocated for the terminal may be always used for ‘D2D Tx’ or ‘D2D Rx’.

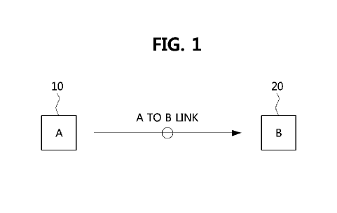

FIG. 1 is a conceptual diagram showing one-way information transmission in device-to-device communication.

Referring to FIG. 1, a terminal A 10 may transmit data (or control information) to a terminal B 20. That is, terminal A 10 may transmit data (that is, D2D-PUSCH) through subframe n to terminal B 20, and terminal B 20 may transmit a response (that is, D2D-HARQ ACK) in response to the data (that is, D2D-PUSCH) received through the subframe n to terminal A 10 through subframe n+k (k is a positive integer). Here, a round trip time (RTT) of D2D-HARQ may be an 8×N-subframe (N is a positive integer).

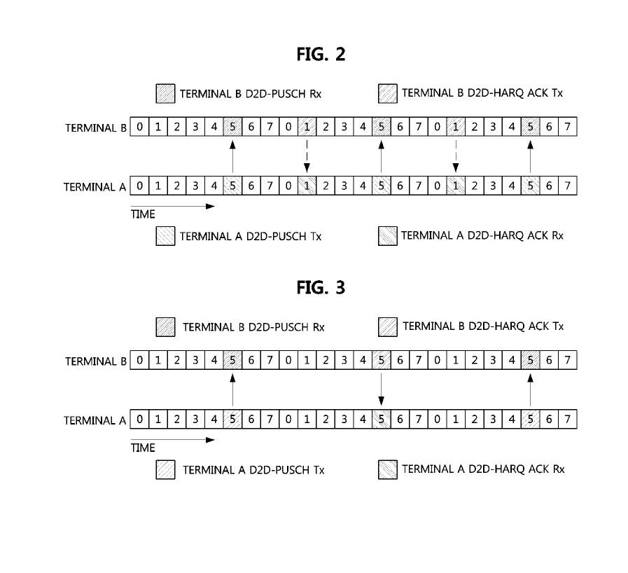

FIG. 2 is a conceptual diagram showing a HARQ process for one-way information transmission in device-to-device communication according to one exemplary embodiment of the present invention.

Referring to FIG. 2, terminal A may transmit D2D-PUSCH to terminal B in subframe n at intervals of 8 subframes, and terminal B may transmit D2D-HARQ ACK to terminal A in subframe n+4. For example, terminal A may transmit D2D-PUSCH to terminal B using subframe 5, and terminal B may transmit D2D-HARQ ACK to terminal A using subframe 1. Here, one HARQ process for device-to-device (D2D) communication may occupy two HARQ processes of the cellular uplink.

FIG. 3 is a conceptual diagram showing a HARQ process for one-way information transmission in device-to-device communication according to another exemplary embodiment of the present invention.

Referring to FIG. 3, terminal A may transmit D2D-PUSCH to terminal B in subframe n at intervals of 16 subframes, and terminal B may transmit D2D-HARQ ACK to terminal A in subframe n+8. For example, terminal A may transmit D2D-PUSCH to terminal B using subframe 5, and terminal B may transmit D2D-HARQ ACK to terminal A using the next subframe 5. Here, one HARQ process for device-to-device (D2D) communication may occupy one HARQ process of the cellular uplink.

The cellular uplink for terminal A or terminal B can use HARQ processes that are not being occupied by the device-to-device (D2D) communication. The cellular downlink for terminal A or terminal B may be scheduled such a way that transmission of C-HARQ ACK in response to reception of C-PDSCH is mapped to an unoccupied HARQ process resource.

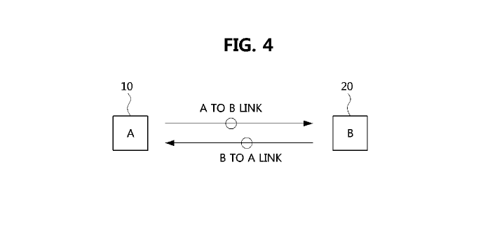

FIG. 4 is a conceptual diagram showing two-way information transmission in device-to-device communication.

Referring to FIG. 4, terminal A 10 may transmit data to terminal B 20, and terminal B 20 may transmit data to terminal A. That is, terminal A 10 or terminal B 20 may transmit D2D-PUSCH through subframe n, and terminal A 10 and terminal B 20 may transmit D2D-HARQ ACK through subframe n+k (k is a positive integer). Here, a round trip time (RTT) of D2D-HARQ may be 8×N subframes (N is a positive integer).

In order to increase the degree of freedom in scheduling of the cellular link, subframes of D2D-PUSCH Tx and D2D-HARQ ACK Tx may be coincided with each other. Accordingly, subframes of D2D-PUSCH Rx and D2D-HARQ ACK Rx may be coincided with each other. This may be represented as follows using the previously defined sets.
D_{PUSCH-Tx}⊃D_{HARQ-ACK-Tx}
D_{PUSCH-Rx}⊃D_{HARQ-ACK-Rx}

That is, a subframe in which HARQ-ACK transmission occurs may correspond to a subframe in which data transmission occurs, and a subframe in which HARQ-ACK reception occurs may correspond to a subframe in which data reception occurs. Except for the first transmission and reception of data, HARQ-ACK and data may be transmitted or received in the same subframe.

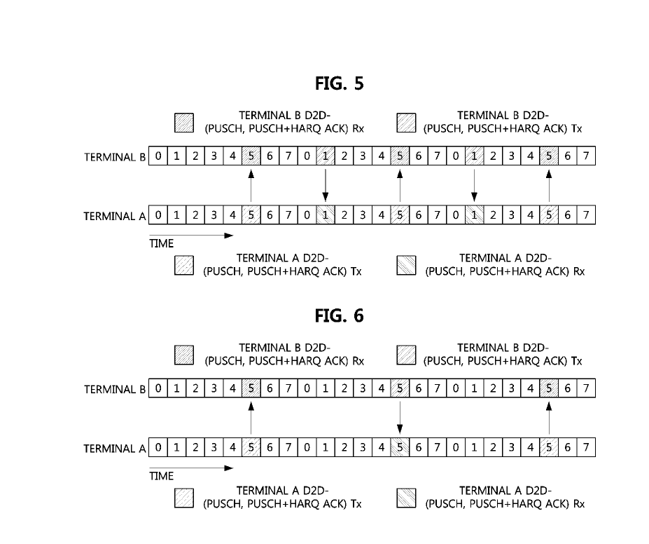

FIG. 5 is a conceptual diagram showing a HARQ process for two-way information transmission in device-to-device communication according to one exemplary embodiment of the present invention.

Referring to FIG. 5, terminal A may transmit D2D-PUSCH and D2D-HARQ ACK to terminal B in subframe n at intervals of 8 subframes, and terminal B may transmit D2D-PUSCH and D2D-HARQ ACK to terminal A in subframe n+4. For example, terminal A may transmit D2D-PUSCH and D2D-HARQ ACK to terminal B in subframe 5, and terminal B may transmit D2D-PUSCH and D2D-HARQ ACK to terminal A in subframe 1. Here, two HARQ processes for device-to-device (D2D) communication may occupy two HARQ processes of the cellular uplink.

FIG. 6 is a conceptual diagram showing a HARQ process for two-way information transmission in device-to-device communication according to another exemplary embodiment of the present invention.

Referring to FIG. 6, terminal A may transmit D2D-PUSCH and D2D-HARQ ACK to terminal B in subframe n at intervals of 16 subframes, and terminal B may transmit D2D-PUSCH and D2D-HARQ ACK to terminal A in subframe n+8. For example, terminal A may transmit D2D-PUSCH and D2D-HARQ ACK to terminal B in subframe 5, and terminal B may transmit D2D-PUSCH and D2D-HARQ ACK to terminal A in subframe 5 in a subsequent period. Here, two HARQ processes for device-to-device (D2D) communication may occupy one HARQ process of the cellular uplink.

The cellular uplink for terminal A or terminal B may use HARQ processes that are not being occupied by the device-to-device (D2D) communication. The cellular downlink for terminal A or terminal B may be scheduled such a way that transmission of C-HARQ ACK in response to reception of C-PDSCH is mapped to a resource of an unoccupied HARQ process.

In the case of resource allocation in which data transmission/reception switching is possible, the terminal for device-to-device (D2D) communication may use a portion of an allocated resource for ‘D2D Tx’. That is, from the point of view of one terminal, the allocated resource may be used for ‘D2D Tx’ or ‘D2D Rx’.

Subframes allocated for device-to-device (D2D) communication may have regular intervals. The intervals of the subframes may be a multiple of a round trip time (RTT) of the HARQ process for the cellular communication. This may mean that the round trip time (RTT) for device-to-device (D2D) communication is a multiple of the round trip time (RTT) of the HARQ process of the cellular communication.

In the case of resource allocation in which data transmission/reception switching is possible, from the point of view of one terminal, the allocated resource may be used for transmission or reception, and if necessary, may switch between transmission and reception.

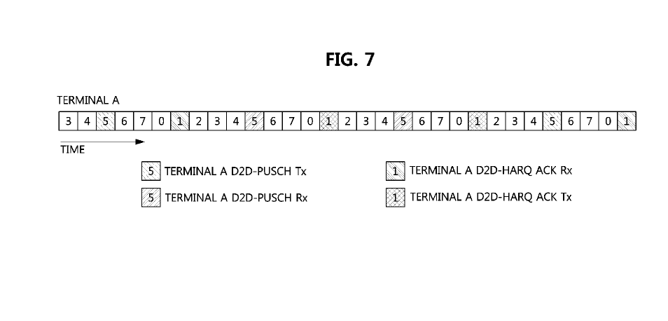

FIG. 7 is a conceptual diagram showing HARQ process for transmission/reception switching in device-to-device communication according to one exemplary embodiment of the present invention.

Referring to FIG. 7, D2D-PUSCH Tx/Rx resources of terminal A and terminal B may have an 8-subframe period. If data transmission of terminal A occurs in subframe n, terminal B may transmit D2D-HARQ ACK in response to the received data in subframe n+4. Further, if data transmission of terminal B occurs in the subframe n, terminal A may transmit D2D-HARQ ACK in the subframe n+4 in response to the received data.

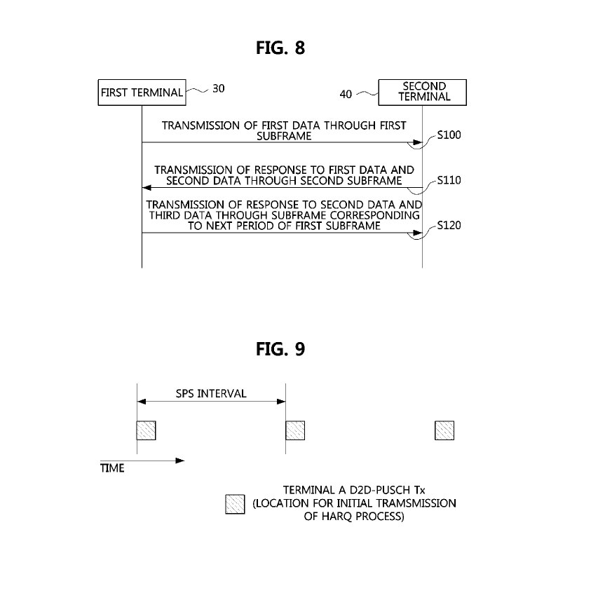

FIG. 8 is a flowchart showing a communication method of a terminal according to a first exemplary embodiment of the present invention.

Referring to FIG. 8, a communication method, performed by a first terminal 30, for direct communication between the first terminal 30 and a second terminal 40 may include a step S100 of transmitting first data to the second terminal 40 through a previously allocated first subframe, a step S110 of receiving a response to the first data and second data through a previously allocated second subframe.

Moreover, the communication method of the first terminal 30 may further include a step S120 of transmitting a response to the second data and third data to the second terminal 40 through a subframe corresponding to a next period of the first subframe.

In step S100, the first terminal 30 may transmit the first data to the second terminal 40 through the first subframe which is previously allocated. The first data may include control information. For example, the first terminal 30 may transmit D2D-PUSCH to the second terminal 40 through the first subframe.

A period of the first subframe may be a multiple of a subframe period decided by a HARQ method for cellular communication. For example, if the subframe period according to the HARQ method of cellular communication is 8 ms, the period of the first subframe may be one among 8 ms, 16 ms, 24 ms, 32 ms, 40 ms, 48 ms, and so on. The first subframe may be allocated by the base station by a semi-persistent scheduling (SPS) method.

In step S110, the first terminal 30 may receive the response to the first data and the second data from the second terminal 40 through the second subframe which is previously allocated. The response to the first data may be a HARQ response with respect to the first data, and the second data may include control information. For example, the first terminal 30 may receive D2D-HARQ ACK (that is, a response to the first data) and D2D-PUSCH (that is, the first data) from the second terminal 40 through the second subframe.

The second subframe may be located a preconfigured number of subframes behind the first subframe. For example, the first subframe may be located at ‘subframe 1’, and if the predetermined number is 4, the second subframe may be located at ‘subframe 5’.

In step S120, the first terminal 30 may transmit the response to the second data and the third data to the second terminal 40 through a subframe corresponding to a next period of the first subframe. The response to the second data may be a HARQ response to the second data, and the third data may include control information. Further, the third data may correspond to retransmission for the first data or may correspond to data which may be different from the first data. For example, the first terminal 30 may transmit D2D-HARQ ACK (that is, the response to the second data) and D2D-PUSCH (that is, the third data) to the second terminal 40 through the subframe corresponding to a next period of the first subframe.

The base station may allocate a resource for device-to-device (D2D) communication to terminals which participate in the device-to-device (D2D) communication, using a method similar to semi-persistent scheduling (SPS) method used in conventional cellular communication. The base station may perform activation, reactivation, and deactivation of the resource using PDCCH or ePDCCH. A resource allocation for D2D-PUSCH Tx and a resource allocation for D2D-PUSCH Rx for the terminals may be independently or simultaneously performed.

A semi-persistent scheduling (SPS) interval in units of subframe may be one among 10, 20, 32, 40, 64, 80, 128, 160, 320, and 640. This semi-persistent scheduling (SPS) interval may mean an interval between HARQ initial transmissions (that is, the first transmissions or new transmissions).

A resource allocation method using semi-persistent scheduling (SPS) method in device-to-device (D2D) communication may be classified into resource allocation without data transmission/reception switching and resource allocation with data transmission/reception switching. In the case of resource allocation method without data transmission/reception switching, the resource allocated by semi-persistent scheduling (SPS) method may be used as a transmission or reception resource, from the point of view of one terminal.

FIG. 9 is a conceptual diagram showing resource allocation using semi-persistent scheduling (SPS) without data transmission/reception switching according to an exemplary embodiment of the present invention.

Referring to FIG. 9, a resource allocated by semi-persistent scheduling may be used as a transmission resource for a transmitting terminal for device-to-device (D2D) communication, and a resource allocated by semi-persistent scheduling may be used as a reception resource for a receiving terminal for device-to-device (D2D) communication. A resource allocated by semi-persistent scheduling (SPS) is a resource for an initial transmission (that is, the first transmission or new transmission) of HARQ, and retransmission with respect to the initial transmission of HARQ can occur according to a HARQ process.

The receiving terminal may transmit D2D-HARQ ACK through subframe n+k (k is a positive integer) with respect to D2D-PUSCH received through subframe n. Here, it may be desirable that the HARQ process for device-to-device (D2D) communication uses a synchronous HARQ in which a round trip time (RTT) is 8×n (n is a positive integer) ms.

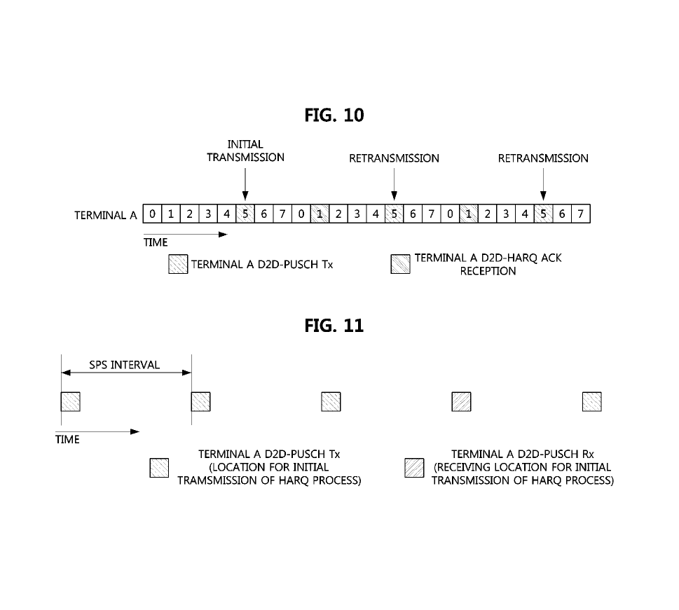

FIG. 10 is a conceptual diagram showing a HARQ process in resource allocation using semi-persistent scheduling according to an exemplary embodiment of the present invention. Here, N may be 1, and k may be 4.

Referring to FIG. 10, terminal A may transmit D2D-PUSCH to terminal B through subframe n at 8-subframe intervals, and terminal A may receive D2D-HARQ ACK with respect to D2D-PUSCH through subframe n+4. For example, terminal A may transmit D2D-HARQ ACK with respect to D2D-PUSCH to terminal B through subframe 5 allocated by semi-persistent scheduling (SPS), and terminal A may receive D2D-HARQ ACK with respect to D2D-PUSCH. Then, terminal A may retransmit D2D-PUSCH to terminal B through a subsequent period of subframe 5.

In the case of resource allocation with data transmission/reception switching, a resource for initial transmission allocated by semi-persistent scheduling (SPS) may be used for transmission or reception from the point of view of one terminal, and if necessary, may switch between transmission and reception. The terminal for device-to-device (D2D) communication may use a portion of the resources allocated for initial transmissions as a ‘D2D Tx’ resource. That is, from the point of view of one terminal, the resources allocated for initial transmissions may be used for ‘D2D Tx’ or ‘D2D Rx’.

FIG. 11 is a conceptual diagram showing resource allocation by semi-persistent scheduling for device-to-device communication according to an exemplary embodiment of the present invention.

Referring to FIG. 11, the resources for initial transmissions allocated by semi-persistent scheduling (SPS) may be used for initial transmissions of terminal A, or initial transmissions of terminal B. A receiving terminal may transmit D2D-HARQ ACK through subframe n+k (k is a positive integer) with respect to D2D-PUSCH received through subframe n. It may be desirable that the HARQ process for device-to-device (D2D) communication uses a synchronous HARQ in which a round trip time (RTT) may be 8×n (n is a positive integer) ms.

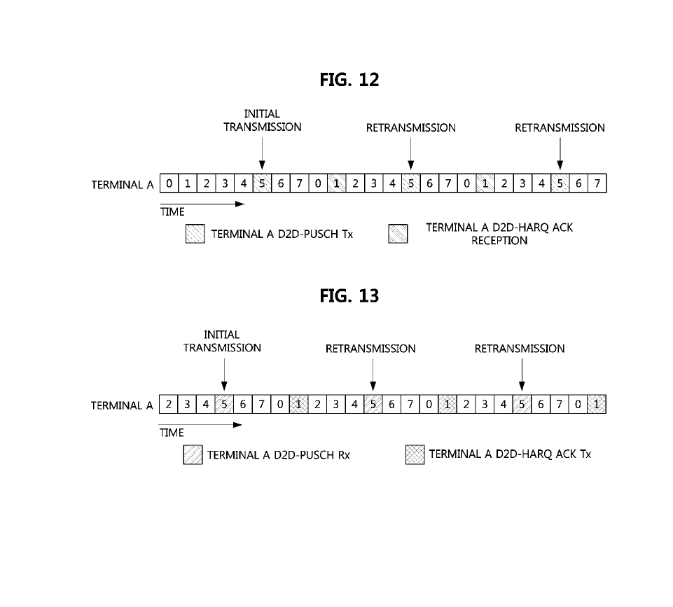

FIG. 12 is a conceptual diagram showing a HARQ process in resource allocation by semi-persistent scheduling according to one exemplary embodiment of the present invention. Here, a round trip time (RTT) of the D2D HARQ process for device-to-device (D2D) communication may be 8 subframes (8 ms).

Referring to FIG. 12, terminal A may transmit D2D-PUSCH to terminal B through subframe 5 allocated by semi-persistent scheduling (SPS), and terminal A may receive D2D-HARQ ACK with respect to D2D-PUSCH from terminal B through subframe 1.

FIG. 13 is a conceptual diagram showing a HARQ process in resource allocation by semi-persistent scheduling according to another exemplary embodiment of the present invention. Here, a round trip time (RTT) of the D2D HARQ process for the device-to-device (D2D) communication may be 8 subframes (8 ms).

Referring to FIG. 13, terminal A may receive D2D-PUSCH from terminal B through subframe 5 allocated by semi-persistent scheduling (SPS), and terminal A may transmit D2D-HARQ ACK with respect to D2D-PUSCH to terminal B through subframe 1.

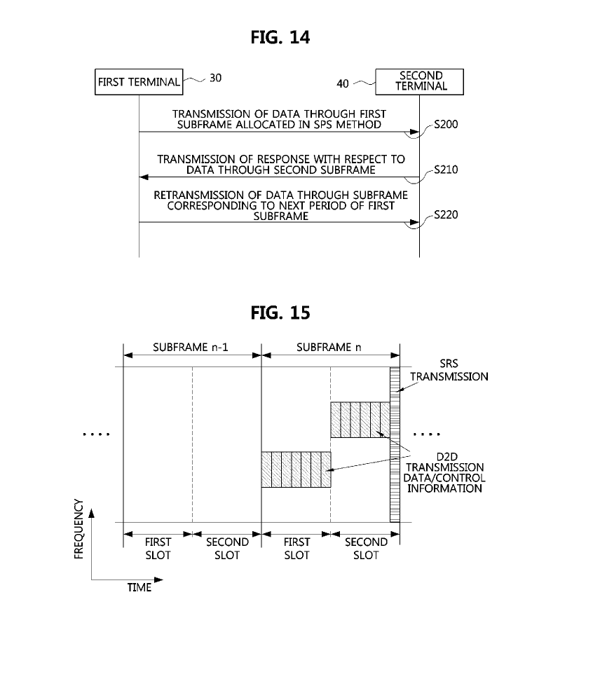

FIG. 14 is a flowchart showing a communication method of a terminal according to a second exemplary embodiment of the present invention.

Referring to FIG. 14, a communication method, performed by a first terminal 30, for direct communication between the first terminal 30 and a second terminal 40 may include a step S200 of transmitting data to the second terminal 40 through a first subframe allocated by a semi-persistent scheduling (SPS) method, and a step S210 of receiving a response to the data through a previously allocated second subframe.

Further, the communication method of the first terminal 30 may further include a step S220 of retransmitting the data to the second terminal 40 through a subframe corresponding to a next period of the first subframe.

In step S200, the first terminal 30 may transmit data to the second terminal 40 through the first subframe allocated by a base station by semi-persistent scheduling. The data may include control information. For example, the first terminal 30 may transmit D2D-PUSCH to the second terminal 40 through the first subframe.

A period of the first subframe may be a multiple of a subframe period decided by the HARQ method for the cellular communication. For example, if a subframe period of the HARQ method for the cellular communication is 8 ms, the period of the first subframe may be one among 8 ms, 16 ms, 24 ms, 32 ms, 40 ms, 48 ms, and so on.

In step S210, the first terminal 30 may receive a response to data from the second terminal 40 through the second subframe which is previously allocated. The response to the data may be a HARQ response to the data. For example, the first terminal 30 may receive D2D-HARQ ACK (that is, the response to the data) from the second terminal 40 through the second subframe.

The second subframe may be located a predetermined number of subframes behind the first subframe. For example, the first subframe may be located at ‘subframe 1’, and if the predetermined number is 4, the second subframe is located at ‘subframe 5’.

In step S220, the first terminal 30 may retransmit data to the second terminal 40 through a subframe corresponding to a next period of the first subframe. For example, if the first subframe is located at ‘subframe 5’, the first terminal 30 may retransmit the data to the second terminal 40 through ‘subframe 5’ located at a next period of the first subframe.

In device-to-device (D2D) communication, a sounding reference signal SRS may be used for (1) a terminal proximity measurement, (2) a path loss estimation for a device-to-device (D2D) communication link, (3) an acquisition of frequency and timing synchronization for a device-to-device (D2D) communication link.

In device-to-device (D2D) communication, sounding reference signals (SRS) may be separately configured to suit their applications, or sounding reference signals (SRS) having the same sounding reference signal (SRS) configuration may be used for multiple applications. Here, for convenience, a reference signal (RS) that the terminal transmits, by using the last OFDM (orthogonal frequency division multiplexing) symbol of a subframe may be called a sounding reference signal (SRS) without distinction of the application.

The base station may configure cell-specific subframes that are used in transmission and reception of sounding reference signals (SRS) for each cell, and inform such configuration to terminals within the cell. The cell-specific sounding reference signal (SRS) subframes may be represented by a period and an offset in units of subframes.

The base station may configure terminal (UE)-specific sounding reference signal (SRS) subframes for each terminal, and a terminal may transmit the sounding reference signals (SRS) in the sounding reference signal (SRS) subframes configured for the terminal. The configuration of the terminal-specific sounding reference signal (SRS) subframes may include a period and an offset in units of subframes.

The cell-specific sounding reference signal (SRS) subframes may have a period of 1, 2, 5 and 10 (units: subframes, TDD: 5, 10 subframes), and the terminal-specific sounding reference signal (SRS) subframes may have a period of 2, 5 10, 20, 40, 80, 160 and 320 (units: subframes).

If a sounding reference signal (SRS) transmission and ‘D2D Rx’ occur in the same subframe, or ‘D2D Rx’ occurs in a subframe right after the sounding reference signal (SRS) transmission, one of the following three methods may be selected as a method for securing Tx/Rx switching time:
(1) a method of performing both ‘D2D Rx’ and the sounding reference signal (SRS) transmission by changing the resource mapping of the device-to-device (D2D) communication;
(2) a method of abandoning ‘D2D Tx’ and transmitting the sound reference signal (SRS); and
(3) a method of abandoning the sound reference signal (SRS) transmission and performing ‘D2D Rx’.

In order to minimize resource loss due to frequent Tx/Rx switching and to reduce complexity in specification and signaling, it may be desirable that sounding reference signal (SRS) transmission and ‘D2D Rx’ do not occur consecutively. Similarly, it may be desirable that sounding reference signal (SRS) reception and ‘D2D Tx’ do not occur consecutively. For these reasons, it may be designed so that sounding reference signal (SRS) transmission and ‘D2D Tx’ occur consecutively, which may have an advantage that sounding reference signal (SRS) reception and ‘D2D Rx’ also occur consecutively. If ‘D2D Tx’ occurs in subframe n, the sounding reference signal (SRS) may be transmitted through the last symbol of subframe n or the last symbol of subframe n−1.

FIG. 15 is a conceptual diagram showing sounding reference signal transmission according to one exemplary embodiment of the present invention.

Referring to FIG. 15, if ‘D2D Tx’ is transmitted through subframe n, the sounding reference signal (SRS) may be transmitted through the last symbol of subframe n.

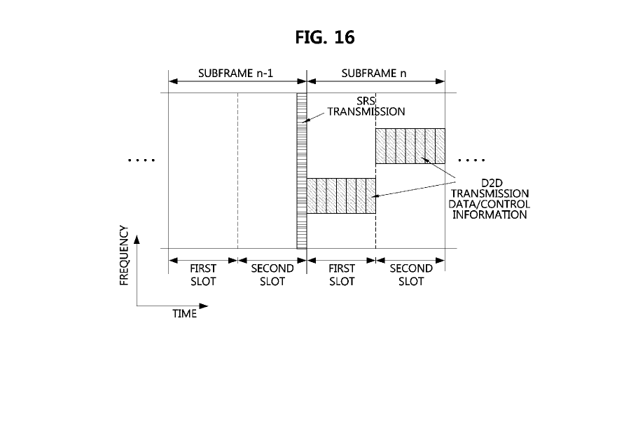

FIG. 16 is a conceptual diagram showing sounding reference signal transmission according to another exemplary embodiment of the present invention.

Referring to FIG. 16, if ‘D2D Tx’ is transmitted through subframe n, the sounding reference signal (SRS) may be transmitted through the last symbol of subframe n−1.

Since the terminal may demodulate data (or control information) transmitted through subframe n after obtaining reception timing from the sounding reference signal (SRS), in order to reduce a demodulation latency, it may be desirable to transmit the sounding reference signal (SRS) using the method shown in FIG. 16.

In the case of sounding reference signal SRS transmission and reception, it may be necessary to consider: (1) minimizing resource loss due to Tx/Rx switching by minimizing Tx/Rx switching, and (2) minimizing a scheduling restriction on cellular communication due to device-to-device (D2D) communication.

As described above, in order to avoid collision between the sounding reference signal (SRS) transmission and ‘D2D Rx’, it may be desirable to transmit the sounding reference signal (SRS) in a subframe (that is, subframe n−1) right before a subframe (that is, subframe n) in which ‘D2D-PUSCH Tx’ occurs. In this way, the problem of collision between the sounding reference signal (SRS) reception and ‘D2D Tx’ may be avoided, since the sounding reference signal (SRS) reception and D2D-PUSCH Rx occur consecutively for the receiving terminal.

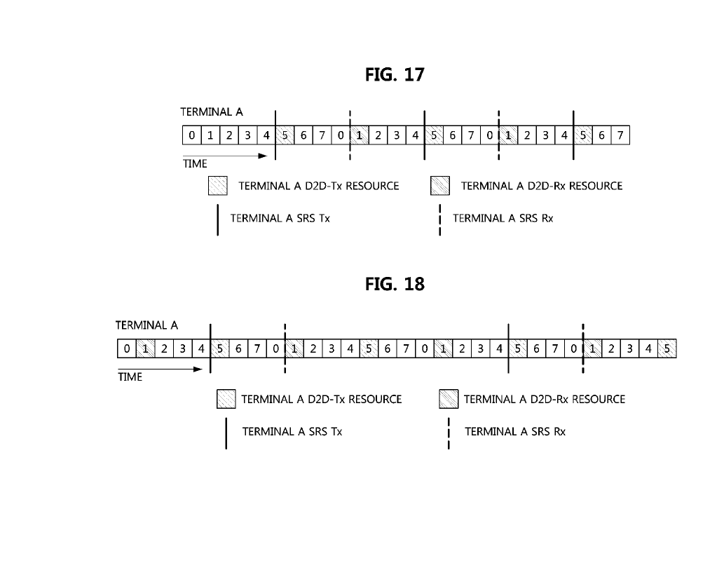

FIG. 17 is a conceptual diagram showing periodic resource allocation and sounding reference signal (SRS) transmission according to one exemplary embodiment of the present invention.

Referring to FIG. 17, a subframe period of the sounding reference signal (SRS) of the terminal may be 8 subframes, and a resource may be allocated in order for ‘D2D Tx’ to occur in a subframe following the subframe in which the sounding reference signal (SRS) transmission occurs. For example, terminal A may transmit the sounding reference signal (SRS) through the last symbol of subframe 4, and data through subframe 5. Here, terminal A may transmit the sounding reference signal (SRS) and data at 8-subframe intervals. On the other hand, terminal A may receive the sounding reference signal (SRS) through the last symbol of subframe 0, and receive data through subframe 1.

FIG. 18 is a conceptual diagram showing periodic resource allocation and sounding reference signal transmission according to another exemplary embodiment of the present invention.

Referring to FIG. 18, a subframe period of the sounding reference signal (SRS) of the terminal may be 16 subframes, a resource may be allocated in order for ‘D2D Tx’ to occur in a subframe following the subframe in which the sounding reference signal (SRS) transmission occurs. That is, terminal A may transmit the sounding reference signal (SRS) through the last symbol of subframe 4, and data through subframe 5. Here, terminal A may transmit the sounding reference signal (SRS) and data at 16-subframe intervals. On the other hand, terminal A may receive the sounding reference signal (SRS) through the last symbol of subframe 0, and data through subframe 1.

However, in an LTE Standard, only the following subframe periods are defined for the sounding reference signal (SRS) and thus using only the following defined cases may cause large restriction in resource scheduling for the device-to-device (D2D) communication methods shown in FIGS. 17 and 18.
cell-specific subframe periods for sounding reference signal (SRS): 1, 2, 5, 10 (units: subframes, TDD: 5, 10 subframes)
terminal-specific subframe periods for sounding reference signal (SRS): 2, 5 10, 20, 40, 80, 160, 320 (units: subframes)

In order to reduce scheduling restriction, additional subframe periods may need to be added to the cell-specific subframe periods for sounding reference signal (SRS) and to the terminal-specific subframe periods for sounding reference signal (SRS).

Hereinafter, the terms ‘sounding reference signal (SRS) subframes’ and ‘terminal sounding reference signal (SRS) subframes’ refer to terminal-specific sounding reference signal (SRS) subframes.

A period of the terminal sounding reference signal (SRS) subframes may be configured as a multiple of a round trip time (RTT) of D2D-HARQ. For example, if the round trip time (RTT) of D2D-HARQ is 8 subframes, the period of the sounding reference signal (SRS) subframes for the terminal may be configured as a multiple of 8. The following are examples of cell-specific subframe periods for sounding reference signal (SRS) and terminal-specific subframe periods for sounding reference signal (SRS), which are additionally configured.
cell-specific subframe periods for sounding reference signal (SRS): 8, 16 (subframes)
terminal-specific subframe periods for sounding reference signal (SRS): 8, 16, 24, 32, 64, 128, 256 (subframes)

If the round trip time (RTT) of D2D-HARQ is 8 subframes, a terminal-specific subframe period for the sounding reference signal (SRS) for a terminal may be configured as 8×N-subframes (N is a positive integer) accordingly, and a subframe offset can be configured such that the sounding reference signal (SRS) is transmitted in a subframe right before a subframe in which ‘D2D Tx’ occurs.

As another method, the sounding reference signal (SRS) may be configured to be transmitted only in a subframe right before a subframe in which ‘D2D Tx’occurs. That is, the terminal may transmit the sounding reference signal (SRS) only if ‘D2D Tx’ occurs in a subframe right after the sounding reference signal (SRS) subframe.

In the case of aperiodic resources allocated for device-to-device (D2D) communication, the sounding reference signal (SRS) may be configured to be transmitted only in a subframe right before a subframe in which ‘D2D Tx’ occurs. That is, the terminal may transmit the sounding reference signal (SRS) only if ‘D2D Tx’ occurs in a subframe right after the sounding reference signal (SRS) subframe.

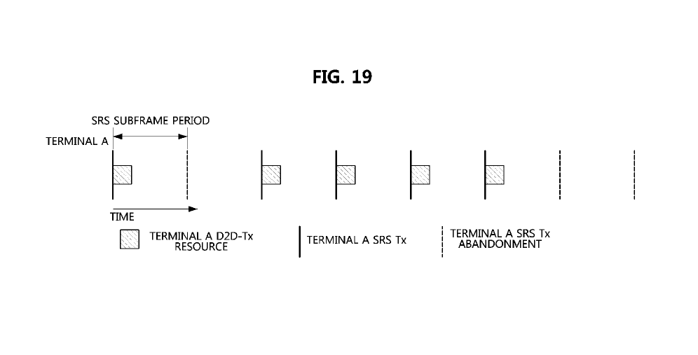

FIG. 19 is a conceptual diagram showing allocation of aperiodic resources and sounding reference signal transmission according to an exemplary embodiment of the present invention.

Referring to FIG. 19, ‘D2D Tx’ may not occur in a next subframe following right after the sounding reference signal (SRS) subframe allocated for a terminal. In this case, sounding reference signal (SRS) transmission may be performed only if ‘D2D Tx’ occurs in the next subframe and otherwise the sounding reference signal (SRS) may not be transmitted (that is, abandonment of the sounding reference signal (SRS) transmission).

In an LTE standard, a semi-persistent scheduling (SPS) interval may have one of the following values in units of subframes. The following semi-persistent scheduling (SPS) interval may mean an interval between initial transmissions (that is, the first transmissions or new transmissions) of HARQ.
semi-persistent scheduling intervals: 10, 20, 32, 40, 64, 80, 128, 160, 320, 640 (units: subframes)

On the other hand, terminal-specific subframe periods for the sounding reference signal (SRS) may have one of the following values in units of subframes.
terminal-specific subframe periods for sounding reference signal SRS: 2, 5 10, 20, 40, 80, 160, 320 (units: subframes)

In the case of adjusting a period and an offset of terminal-specific sounding reference signal (SRS) subframes, the sounding reference signal (SRS) transmission may be adjusted to always occur in a subframe right before a subframe in which an initial transmission by semi-persistent scheduling (SPS) occurs.
(example) SPS interval=10, SRS subframe period=10
(example) SPS interval=40, SRS subframe period=80

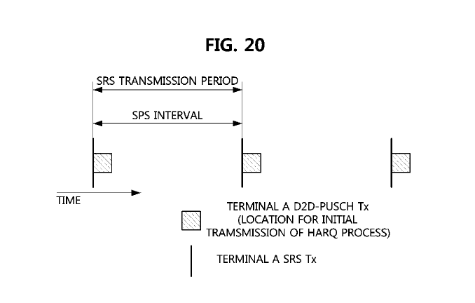

FIG. 20 is a conceptual diagram showing resource allocation by semi-persistent scheduling according to one exemplary embodiment of the present invention.

Referring to FIG. 20, even in the case of semi-persistent scheduling (SPS), the sounding reference signal (SRS) may be configured to be transmitted only in a subframe right before a subframe in which ‘D2D Tx’ occurs. That is, the terminal may transmit the sounding reference signal (SRS) only if ‘D2D Tx’ occurs in a subframe right after the sounding reference signal (SRS) subframe.

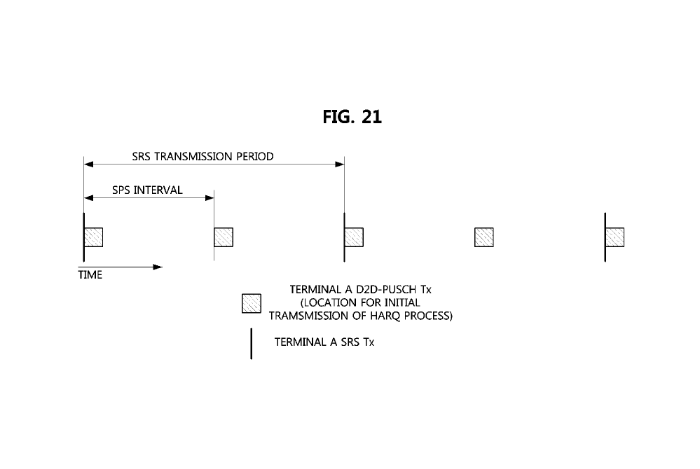

FIG. 21 is a conceptual diagram showing resource allocation by semi-persistent scheduling according to another exemplary embodiment of the present invention.

Referring to FIG. 21, a subframe period of the sounding reference signal (SRS) of the terminal may be 2 times a semi-persistent scheduling (SPS) interval. If an initial transmission by semi-persistent scheduling (SPS) occurs in a subframe right after the sounding reference signal (SRS) subframe of the terminal, Terminal A may transmit the sounding reference signal (SRS) of the terminal.

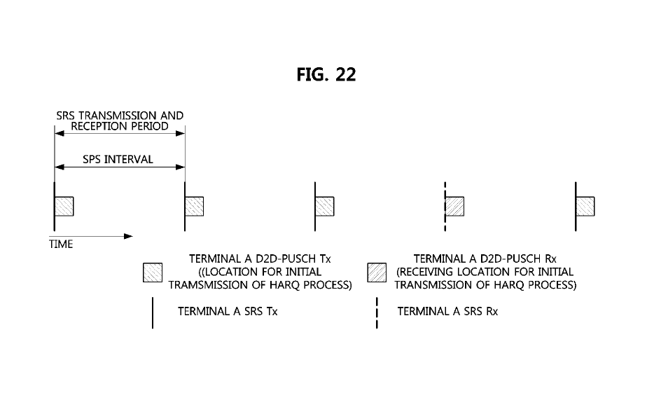

FIG. 22 is a conceptual diagram showing resource allocation by aperiodic semi-persistent scheduling according to an exemplary embodiment of the present invention.

Referring to FIG. 22, resources for initial transmissions in device-to-device (D2D) communication may be allocated periodically but transmission resources for initial transmissions and reception resources for initial transmissions for the terminal may not be allocated periodically.

The sounding reference signal (SRS) transmission of the terminal may be performed only if: (1) a corresponding subframe is a sounding reference signal (SRS) subframe of the terminal and, (2) its own ‘D2D Tx’ occurs in a subframe immediately following the sounding reference signal (SRS) subframe. Further, the sounding reference signal (SRS) may be transmitted using the following methods.
[method 1] If the period of initial transmission resources by semi-persistent scheduling (SPS) and the period of sounding reference signals (SRS) are equal to each other, the sounding reference signal (SRS) is transmitted only for the initial transmissions and not for retransmissions.
[method 2a] In the case of an initial transmission, a sounding reference signal (SRS) is always transmitted. In the case of a retransmission, sounding reference signal (SRS) subframes for retransmission are additionally configured, and a sounding reference signal (SRS) is transmitted only when a retransmission occurs in a subframe right after a sounding reference signal (SRS) subframe for retransmission.
[method 2b] Only one subframe period for sounding reference signal (SRS) is configured without distinguishing initial transmission and retransmission, and a sounding reference signal (SRS) is transmitted when a subframe right after a sounding reference signal (SRS) subframe of the terminal is a subframe in which an initial transmission or a retransmission occurs.

If a round trip time (RTT) of D2D-HARQ is 8 subframes, the terminal-specific subframe period of the sounding reference signal (SRS) of a terminal for the retransmission may be set as 8×N subframes (N is a positive integer) accordingly. In case the round trip time (RTT) of D2D-HARQ is 16 subframes, the terminal-specific subframe period of the sounding reference signal (SRS) of a terminal may be set as 16×N subframes (N is a positive integer) accordingly. This may serve to avoid a collision with HARQ processes for cellular communication.

D2D-HARQ ACK transmitted by the terminal that receives data may be mapped to a ‘D2D Rx’ resource from the perspective of the terminal that transmits the data. The terminal transmitting D2D-HARQ ACK may transmit a sounding reference signal (SRS) in accordance with the configuration of the sounding reference signal (SRS) if D2D-HARQ ACK is transmitted in a subframe right after a sounding reference signal (SRS) subframe of the terminal. The period of the sounding reference signal (SRS) subframes may be configured to be similar to the case of the data transmitting terminal.

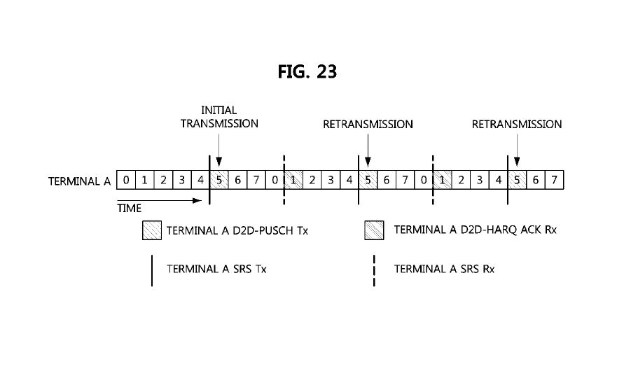

FIG. 23 is a conceptual diagram showing retransmission and sounding reference signal transmission/reception according to one exemplary embodiment of the present invention.

Referring to FIG. 23, a round trip time (RTT) of D2D-HARQ may be 8 subframes, and also a period of sounding reference signal (SRS) subframes for retransmission may be 8 subframes. D2D-HARQ ACK transmitted by a counterpart terminal may be mapped to a ‘D2D Rx’ resource of a terminal, and the sounding reference signal (SRS) transmitted by the counterpart terminal may be mapped to a subframe right before the ‘D2D Rx’ resource of the terminal. Here, the period of the sounding reference signal (SRS) subframes of the counterpart terminal may be 8 subframes.

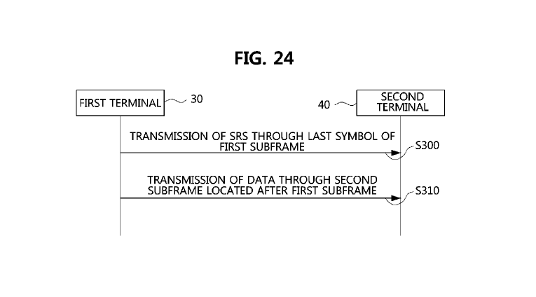

FIG. 24 is a flowchart showing a communication method of a terminal according to a third exemplary embodiment of the present invention.

Referring to FIG. 24, a communication method of the first terminal 30 for direct communication between the first terminal 30 and the second terminal 40, may include a step S300 transmitting a sounding reference signal (SRS) to the second terminal 40 through the last symbol of a previously allocated first subframe, and a step S310 transmitting data to the second terminal 40 through the second subframe right after to the first subframe.

In step S300, the first terminal 30 may transmit a sounding reference signal (SRS) to the second terminal 40 through the last symbol of the previously allocated first subframe. For example, if one slot is composed of 7 symbols (0˜6), the first terminal 30 may transmit a sounding reference signal (SRS) to the second terminal 40 through the seventh symbol (6) of the second slot of the first subframe. On the other hand, if one slot is composed of 6 symbols (0˜5), the first terminal 30 may transmit a sounding reference signal (SRS) to the second terminal 40 through the sixth symbol (5) of the second slot of the first subframe.

The period of the first subframe may be a multiple of the subframe period decided by the HARQ method for cellular communication. For example, if the subframe period of the HARQ method for cellular communication is 8 ms, the period of the first subframe may be one among 8 ms, 16 ms, 24 ms, 32 ms, 40 ms, 48 ms, and so on. The data here may include control information.

In transmitting the sounding reference signal (SRS), the first terminal 30 may transmit the sounding reference signal (SRS) to the second terminal 40 in the last symbol of the first subframe if there is data transmission in the second subframe.

In transmitting the sounding reference signal (SRS), the first terminal 30 may transmit the sounding reference signal (SRS) to the second terminal 40 in the last symbol of the first subframe if the second subframe is allocated by the base station by a semi-persistent scheduling (SPS) method.

In transmitting the sounding reference signal (SRS), the first terminal 30 may transmit the sounding reference signal (SRS) to the second terminal 40 in the last symbol of the first subframe if the second subframe is allocated by the base station by the semi-persistent scheduling (SPS) method and there is data transmission in the second subframe.

In transmitting the sounding reference signal (SRS), the first terminal 30 may transmit the sounding reference signal (SRS) to the second terminal 40 in the last symbol of the first subframe if the data transmission corresponds to an initial transmission of the HARQ method for the device-to-device (D2D) communication.

In step S310, the first terminal 30 may transmit data to the second terminal 40 through the second subframe which is located after the first subframe.

In the above, the case, where the sounding reference signal (SRS) is transmitted right before ‘D2D Tx’ subframe, has been explained in detail. In the following, the case, where the sounding reference signal (SRS) transmission is performed in the same subframe as ‘D2D Tx’ subframe, will be explained in detail.

If the sounding reference signal (SRS) transmission is configured to be performed in a subframe, in which ‘D2D Tx’ occurs, the sounding reference signal (SRS) reception and D2D-PUSCH Rx occurs in the same subframe from the perspective of the receiving terminal of the device-to-device (D2D) communication. Thus, a collision between the sounding reference signal (SRS) reception and ‘D2D Tx’ may not occur.

Similar to the case where the sounding reference signal (SRS) transmission is performed in a subframe right before a subframe in which ‘D2D Tx’ occurs, in order to alleviate scheduling restriction, additional cell-specific subframe periods for the sounding reference signal (SRS) and additional terminal-specific subframe periods for the sounding reference signal (SRS) may be necessary.

A terminal-specific subframe period of the sounding reference signal (SRS) may be configured as a multiple of a round trip time (RTT) of D2D-HARQ. For example, if a round trip time (RTT) of D2D-HARQ is 8 subframes, a terminal-specific subframe period for the sounding reference signal (SRS) may be configured as a multiple of 8 subframes. The following is an example of additional cell-specific/terminal-specific subframe periods for the sounding reference signal (SRS), which are added to the existing cell-specific/terminal-specific subframe periods of the sounding reference signal (SRS) of LTE.
cell-specific subframe periods for the sounding reference signal (SRS): 8, 16 (units: subframes)
terminal-specific subframe periods for the sounding reference signal (SRS): 8, 16, 24, 32, 64, 128, 256 (units: subframes)

If the round trip time RTT of D2D-HARQ is 8 subframes, a subframe period for the sounding reference signal (SRS) for the terminal may be configured as 8×N subframes (N is a positive integer) accordingly, and a subframe offset may be configured so that the sounding reference signal (SRS) transmission occurs at the same location.

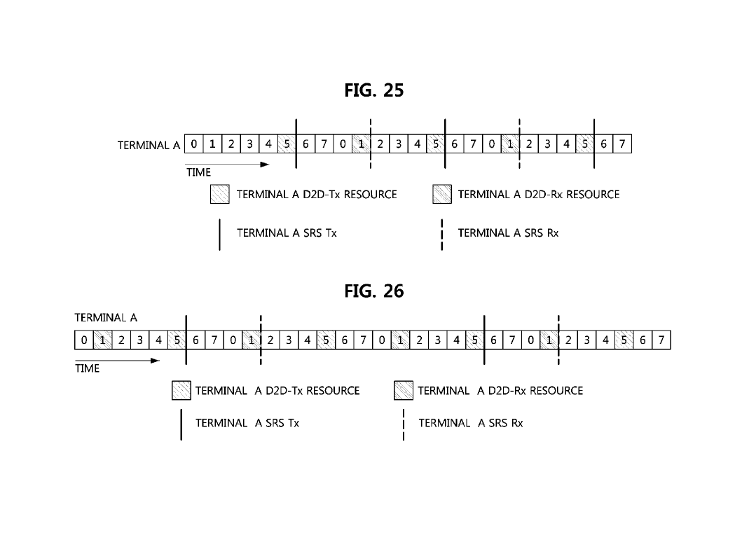

FIG. 25 is a conceptual diagram showing periodic resource allocation and sounding reference signal transmission according to one exemplary embodiment of the present invention.

Referring to FIG. 25, a subframe period for the sounding reference signal (SRS) for the terminal may be 8 subframes, and a resource allocation may be done in such a way that the sounding reference signal (SRS) transmission and ‘D2D Tx’ occur in the same subframe.

FIG. 26 is a conceptual diagram showing periodic resource allocation and sounding reference signal transmission according to another exemplary embodiment of the present invention.

Referring to FIG. 26, a subframe period of the sounding reference signal (SRS) of the terminal may be 16 subframes, and a resource allocation may be done in such a way that a sounding reference signal (SRS) transmission and ‘D2D Tx’ occur in the same subframe.

In the case of an aperiodic ‘D2D Tx’ resource allocation, the sounding reference signal (SRS) may be configured to be transmitted only in a subframe in which ‘D2D Tx’ occurs. That is, the terminal may actually transmit a sounding reference signal (SRS) only if ‘D2D Tx’ occurs in a sounding reference signal (SRS) subframe of the terminal.

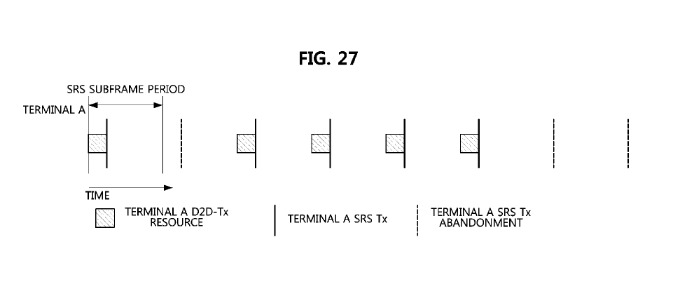

FIG. 27 is a conceptual diagram showing an aperiodic resource allocation and sounding reference signal transmission according to one exemplary embodiment of the present invention.

Referring to FIG. 27, a sounding reference signals (SRS) subframe of the terminal may not always be the same as a subframe in which ‘D2D Tx’ occurs. That is, terminal A may transmit a sounding reference signal (SRS) only if a sounding reference signal (SRS) subframe coincides with a subframe in which ‘D2D Tx’ occurs, and otherwise, terminal A may not transmit a sounding reference signal (SRS) (that is, the sounding reference signal (SRS) transmission may be abandoned).

In the case of resource allocation by semi-persistent scheduling (SPS), the subframe period and the offset for the sounding reference signal (SRS) for the terminal may be adjusted so that a sounding reference signal (SRS) transmission is always generated in a subframe in which an initial transmission by semi-persistent scheduling (SPS) occurs.
(example) SPS interval=10, SRS subframe period=10, the same subframe offset.
(example) SPS interval=40, SRS subframe period=80, the same subframe offset.

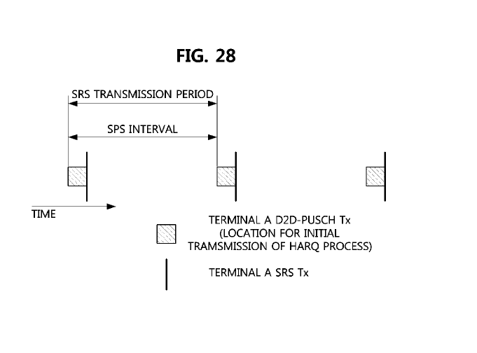

FIG. 28 is a conceptual diagram showing resource allocation by semi-persistent scheduling according to one exemplary embodiment of the present invention.

Referring to FIG. 28, a sounding reference signal (SRS) transmission may occur only in a subframe in which an initial transmission by semi-persistent scheduling SPS occurs. That is, terminal A may transmit D2D-PUSCH and a sounding reference signal (SRS) in the same subframe.

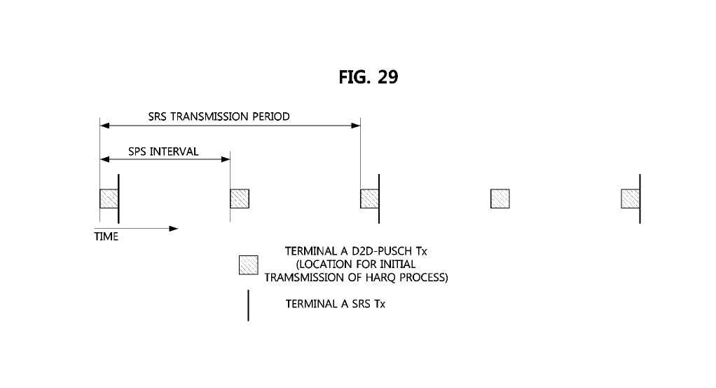

FIG. 29 is a conceptual diagram showing resource allocation by semi-persistent scheduling according to another exemplary embodiment of the present invention.

Referring to FIG. 29, a sounding reference signal (SRS) transmission may occur in a subframe in which an initial transmission by semi-persistent scheduling (SPS) occurs. That is, terminal A may transmit D2D-PUSCH and a sounding reference signal (SRS) in the same subframe.

In the case of a resource allocation by a semi-persistent scheduling (SPS), a sounding reference signal (SRS) may be configured to be transmitted only in a subframe in which ‘D2D Tx’ occurs. That is, the terminal may actually transmit a sounding reference signal (SRS) if ‘D2D Tx’ occurs in a sounding reference signal (SRS) subframe.

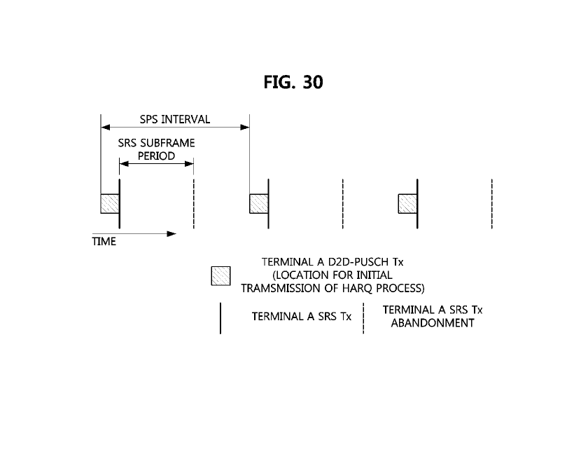

FIG. 30 is a conceptual diagram showing sounding reference signal transmission by a semi-persistent scheduling according to an exemplary embodiment of the present invention.

Referring to FIG. 30, the subframe period for the sounding reference signal (SRS) may be a half of a semi-persistent scheduling (SPS) interval. Terminal A may transmit a sounding reference signal (SRS) only in a subframe in which an initial transmission by a semi-persistent scheduling (SPS) occurs, and otherwise may not transmit a sounding reference signal (SRS) (that is, the sounding reference signal (SRS) transmission may be abandoned).

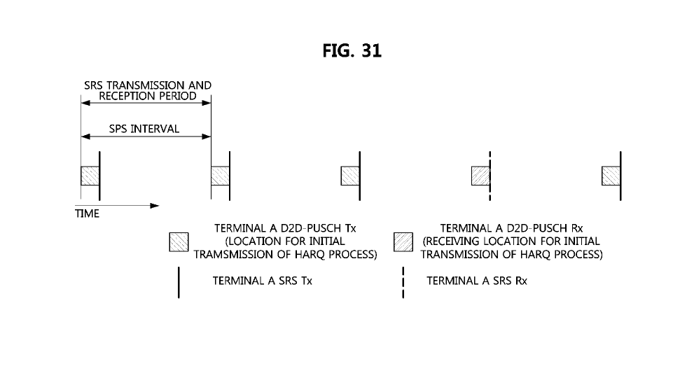

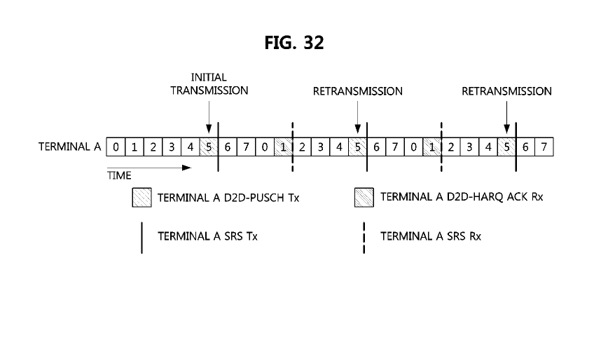

FIG. 31 is a conceptual diagram showing sounding reference signal transmission according to aperiodic semi-persistent scheduling according to an exemplary embodiment of the present invention.

Referring to FIG. 31, ‘D2D Tx/Rx’ resources for initial transmissions may be allocated periodically, but transmission resources and reception resources for initial transmissions for one terminal may not be allocated periodically.

A sounding reference signal (SRS) transmission by each terminal may be allowed only in a subframe in which ‘D2D Tx’ of the terminal occurs. In detail, a sounding reference signal (SRS) may be transmitted using one of the following methods.
[method 1] If the period of initial transmission resources allocated by semi-persistent scheduling (SPS) and a subframe period for the sounding reference signal (SRS) are equal to each other, a sounding reference signal (SRS) is transmitted only for an initial transmission and not for a retransmission.
[method 2a] In the case of an initial transmission, a sounding reference signal (SRS) is always transmitted. In the case of retransmissions, sounding reference signal (SRS) subframes for retransmissions are additionally configured, and a sounding reference signal (SRS) is transmitted only if a sounding reference signal subframe for retransmissions and a retransmission subframe occur in the same subframe.
[method 2b] Only one subframe period for the sounding reference signal (SRS) is configured without distinguishing initial transmission and retransmission, and a sounding reference signal (SRS) is transmitted only if a sounding reference signal (SRS) subframe and a subframe in which an initial transmission or a retransmission occurs coincide with each other.

If a round trip time (RTT) of D2D-HARQ is 8 subframes (that is, 8 ms), the subframe period for the sounding reference signal (SRS) for retransmission for a terminal may be configured to be 8×N subframes (N is a positive integer). If a round trip time (RTT) of D2D-HARQ is 16 subframes (that is, 16 ms), the subframe period of the sounding reference signal (SRS) for retransmission for a terminal may be configured to be 16×N (N is a positive integer) subframes. This may serve to avoid a collision with HARQ processes for cellular communication.

D2D-HARQ ACK transmitted by the terminal that receives data may be mapped to a ‘D2D Rx’ resource from the perspective of the terminal that transmits the data. The terminal transmitting D2D-HARQ ACK may transmit the sounding reference signal (SRS) in accordance with the configuration of the sounding reference signal (SRS) if D2D-HARQ ACK is transmitted in a sounding reference signal (SRS) subframe of the terminal. The subframe period for the sounding reference signal (SRS) may be configured to be similar to the case of the data transmitting terminal.

FIG. 32 is a conceptual diagram showing retransmission and sounding reference signal transmission according to an exemplary embodiment of the present invention.

Referring to FIG. 32, a round trip time (RTT) of D2D-HARQ may be 8 subframes (8 ms), and a subframe period for the sounding reference signal (SRS) for retransmissions may also be 8 subframe (8 ms). Both D2D-HARQ ACK and the sounding reference signal (SRS) of a counterpart terminal may be mapped to a ‘D2D Rx’ resource of a terminal. Here, the subframe period for the sounding reference signal (SRS) of the counterpart terminal may also be 8 subframes (8 ms).

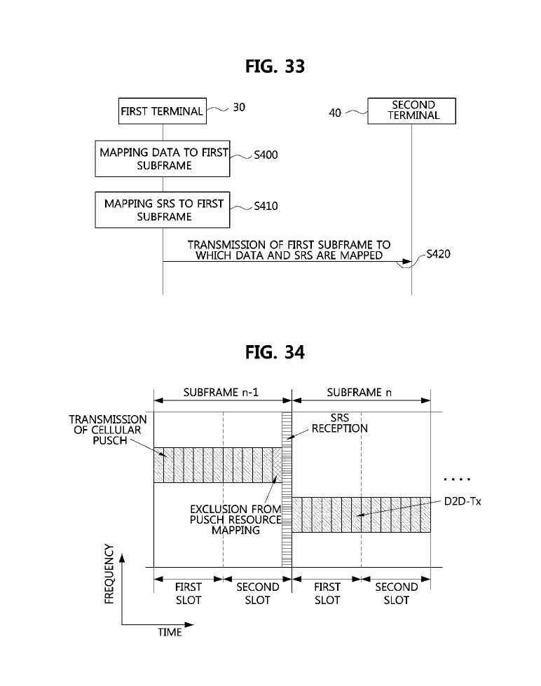

FIG. 33 is a flowchart showing a communication method of a terminal according to a fourth exemplary embodiment of the present invention.

Referring to FIG. 33, a communication method of the first terminal 30, for direct communication between the first terminal 30 and the second terminal 40, may include a step S400 of mapping data to a previously allocated first subframe, a step S410 of mapping a sounding reference signal (SRS) to the last symbol of the first subframe, and a step S420 of transmitting the first subframe to which data and the sounding reference signal (SRS) are mapped to the second terminal 40.

In step S400, the first terminal 30 may map data to the previously allocated first subframe. For example, if one slot is composed of 7 symbols, the first terminal 30 may map data to 0˜6 symbols of the first slot and 0˜5 symbols of the second slot. On the other hand, if one slot is composed of 6 symbols, the first terminal 30 may perform map data to 0˜5 symbols of the first slot and 0˜4 symbols of the second slot.

A period of the first subframe may be a multiple of the subframe period decided by the HARQ method for cellular communication. For example, if the subframe period of the HARQ method for cellular communication is 8 ms, the period of the first subframe may be one of 8 ms, 16 ms, 24 ms, 32 ms, 40 ms, 48 ms, and so on. The data here can include control information.

In step S410, the first terminal 30 may map the sounding reference signal (SRS) to the last symbol of the first subframe. For example, if one slot is composed of 7 symbols, the first terminal 30 may map the sounding reference signal (SRS) to the seventh symbol (6) of the second slot of the first subframe. On the other hand, if one slot is composed of 6 symbols, the first terminal 30 may map the sounding reference signal (SRS) to the sixth symbol (5) of the second slot of the first subframe.

In the case of mapping the sounding reference signal SRS, if data transmission corresponds to an initial transmission of a HARQ method for the device-to-device (D2D) communication, the first terminal 30 may map the sounding reference signal (SRS) to the last symbol of the first subframe.

In step S420, the first terminal 30 may transmit the first subframe in which data and the sounding reference signal (SRS) are mapped to the second terminal 40.

As shown in FIG. 16, if a sounding reference signal (SRS) transmission is performed in a subframe right before a ‘D2D Tx’ subframe, a cellular Tx may not occur in a subframe right after the sounding reference signal (SRS) reception. However, the sounding reference signal (SRS) reception and the cellular Tx may occur within the same subframe. These problems may be avoided by using one of the following three methods:
(1) a method of changing the cellular Tx resource allocation and performing both the cellular Tx and the sounding reference signal (SRS) reception;
(2) a method abandoning the cellular Tx and receiving the sounding reference signal (SRS); and
(3) a method abandoning the sounding reference signal (SRS) reception and performing the cellular Tx.

In the case of changing the cellular Tx resource allocation and performing both the cellular Tx and the sounding reference signal (SRS) reception, if the cellular Tx is C-PUCCH, a format change and a resource allocation change may be needed. On the other hand, if the cellular Tx is C-PUSCH, the second last OFDM symbol of the second slot may be excluded from the resource mapping.

If the cellular Tx is restricted, scheduling may be performed so that C-PUCCH and the sounding reference signal (SRS) do not occur in the same subframe. Further, scheduling may be performed in such a way that C-PUSCH and the sounding reference signal (SRS) do not occur in the same subframe.

If the sounding reference signal (SRS) reception is abandoned and the cellular Tx is performed, the frequency of abandonment of the sounding reference signal (SRS) reception may need to be reduced by adjusting scheduling of the cellular Tx, in order to avoid a problem due to the frequent abandonment of the sounding reference signal (SRS) reception.

FIG. 34 is a conceptual diagram showing C-PUSCH transmission and sounding reference signal reception within the same subframe according to an exemplary embodiment of the present invention.

Referring to FIG. 34, both C-PUSCH transmission and sounding reference signal (SRS) reception may occur in subframe n−1. In this case, the second last OFDM symbol from the second slot in subframe n−1 may be excluded from the resource mapping.

As shown in FIG. 15, if a sounding reference signal (SRS) transmission is performed only in a ‘D2D Tx’ subframe, the sounding reference signal (SRS) reception and the cellular Tx may not take place in the same subframe. However, the cellular Tx may occur in a subframe right after the sounding reference signal (SRS) reception. These problems may be solved using one of the following three methods:
(1) a method of changing the cellular Tx resource allocation and performing both the cellular Tx and the sounding reference signal (SRS) reception;
(2) a method of abandoning the cellular Tx and receiving the sounding reference signal (SRS);
(3) a method of abandoning the sounding reference signal (SRS) reception and performing the cellular Tx.

In the case of changing the cellular Tx resource allocation and performing both the cellular Tx and the sounding reference signal (SRS) reception, if the cellular Tx is C-PUUCH, a format change and a resource allocation change may be needed. On the other hand, if the cellular Tx is C-PUSCH, the first OFDM symbol of the first slot may be excluded from the resource mapping.

If the cellular Tx is restricted, scheduling may be performed to prevent C-PUCCH and the sounding reference signal (SRS) reception from occurring in the same subframe. Further, scheduling may be performed to make C-PUSCH and the sounding reference signal (SRS) reception do not occur in the same subframe.

In the case of abandoning the sounding reference signal (SRS) reception and performing the cellular Tx, the frequency of abandonment of the sounding reference signal (SRS) reception may need to be reduced by adjusting scheduling of the cellular Tx, in order to avoid a problem due to frequent abandonment of the sounding reference signal (SRS) reception.

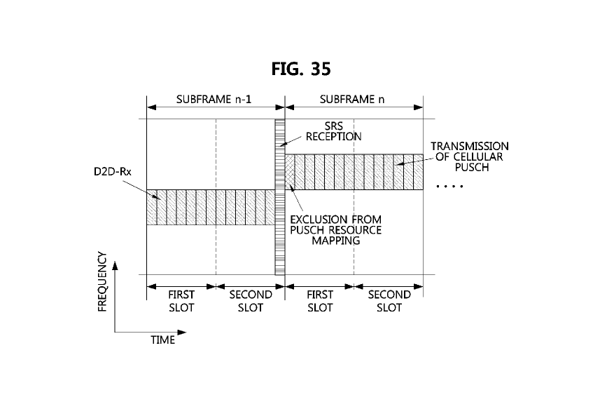

FIG. 35 is a conceptual diagram showing C-PUSCH transmission and a sounding reference signal (SRS) reception in different subframes according to an exemplary embodiment of the present invention.

Referring to FIG. 35, a sounding reference signal (SRS) may be received in subframe n−1, and C-PUSCH may be transmitted in subframe n. In this case, the first OFDM symbol within the first slot of the subframe n may be excluded from the resource mapping.

In the above, detailed explanation is provided regarding resource allocation allowing transmission/reception switching. In the following, detailed explanation is provided for a transmission/reception switching process.

A terminal in data receiving status may transmit scheduling request information to a counterpart terminal for a switching to data transmission status. The scheduling request information may be denoted by ‘D2D-SR (scheduling request)’.

If terminal A transmits data and terminal B receives data, terminal A may monitor whether terminal B transmits D2D-SR or not. If a resource for transmitting the data is needed, terminal B may transmit D2D-SR to terminal A. If terminal A receives D2D-SR, terminal A may transmit a response to D2D-SR to terminal B, and terminal B may receive the response to D2D-SR. If the response indicates a transmission allowance, terminal A may stop data transmission and terminal B may start data transmission.

If terminal B transmits data and terminal A receives the data, terminal B may monitor whether terminal A transmits D2D-SR or not. If terminal B receives D2D-SR from terminal A, terminal B may transmit a response to D2D-SR to terminal A, and terminal A may receive the response to D2D-SR. If the response indicates a transmission allowance, terminal B may stop data transmission and terminal B may start data transmission.

A terminal in data transmission status may send a data transmission request to the data receiving terminal. In this case, the data transmission terminal may transmit the transmission request together with its own data.

Further, if the data transmission terminal confirms its own data buffer status, and determines that there is no more data to transmit, the data transmission terminal may transfer a ‘transmission right’ to the data receiving terminal A data transmission right transfer message may be transmitted together with its own data to a counterpart terminal. If the terminal to which the transmission right has been transferred also checks its own data buffer status and determines that there is no more data to transmit, the terminal to which the transmission right has been transferred may transfer the transmission right back to the counterpart terminal through a data transmission right transfer message.

An additional transmission format may be needed for transmitting scheduling request information for the transmission/reception switching. The scheduling request information may be denoted by D2D-SR. The following description concerns resource allocation and a transmission format which may be used for D2D-SR transmission.

The base station may allocate D2D-SR resources to the terminal. A D2D-SR transmission format may use the PUCCH format 1 of the LTE standard. In this case, the base station may provide the terminal with information regarding resource allocation and the transmission format of PUCCH format 1 as follows.
A resource allocation method of the LTE PUCCH format 1 may be used. That is, the base station as described in LTE TS 36.211 Sec 5.4.1 may signal a resource index to the terminal, and a PUCCH resource corresponding to the resource index may be used by the terminal.
The base station may inform the terminal of a virtual cell ID in order to designate a base sequence and a cyclic shift hopping (CSH) pattern of DM RS of the PUCCH format 1. In this case, the terminal may generate the base sequence and the cyclic shift hopping (CSH) pattern of DM RS of the PUCCH format 1 by substituting the virtual cell ID for the physical layer cell ID (PCI).

If a PUCCH format 1a (or 1b) transmission for a D2D-HARQ ACK transmission and a PUCCH format 1 for a D2D-SR transmission occur in the same subframe, D2D-HARQ ACK information may be transmitted in a D2D-SR resource using the PUCCH format 1a (or 1b).

While the invention has been shown and described with reference to certain exemplary embodiments thereof, it will be understood by those skilled in the art that various changes in form and details may be made therein without departing from the spirit and scope of the invention as defined by the appended claims.

1. A method, performed by a first terminal, for direct communication between the first terminal and a second terminal, comprising:
transmitting first data to the second terminal through a previously allocated first subframe; and
receiving a response to the first data and second data from the second terminal through a previously allocated second subframe.

2. The method according to claim 1, further comprising:
transmitting a response to the second data and third data to the second terminal through a subframe corresponding to a next period of the first subframe.

3. The method according to claim 1, wherein the response to the first data is a HARQ (hybrid automatic repeat-request) response for the first data.

4. The method according to claim 1, wherein the first data is control information.

5. The method according to claim 2, wherein the third data is retransmission data with respect to the first data.

6. The method according to claim 1, wherein the period of the first subframe is a multiple of the round trip time of HARQ processes for cellular communication.

7. The method according to claim 1, wherein the first subframe is allocated by a base station by a semi-persistent scheduling (SPS) method.

8. A method, performed by a first terminal, for direct communication between the first terminal and a second terminal, comprising:
transmitting data to the second terminal through a first subframe which is allocated by a semi-persistent scheduling (SPS) method; and
receiving a response to the data from the second terminal through a previously allocated second subframe.

9. The method according to claim 8, further comprising:
retransmitting the data to the second terminal through a subframe corresponding to a next period of the first subframe.

10. The method according to claim 8, wherein a period of the first subframe is a multiple of the round trip time of HARQ processes for cellular communication.

11. The method according to claim 8, wherein the response to the data is a HARQ (hybrid automatic repeat-request) response for the data.

12. A method, performed by a first terminal, for direct communication between the first terminal and a second terminal, comprising:
transmitting a sounding reference signal (SRS) to the second terminal through the last symbol of a previously allocated first subframe; and
transmitting data to the second terminal through a second subframe which is located after the first subframe.

13. The method according to claim 12, wherein a period of the first subframe is a multiple of the round trip time of HARQ processes for cellular communication.

14. The method according to claim 12, wherein, in transmitting the sounding reference signal (SRS) to the second terminal through the last symbol of the previously allocated first subframe,
if there is data transmitted through the second subframe, the sounding reference signal is transmitted to the second terminal through the last symbol of the first subframe.

15. The method according to claim 12, wherein, in transmitting the sounding reference signal (SRS) to the second terminal through the last symbol of the previously allocated first subframe,
if the second subframe is allocated by a base station by a semi-persistent scheduling (SPS) method, the sounding reference signal is transmitted to the second terminal through the last symbol of the first subframe.

16. The method according to claim 12, wherein, in transmitting the sounding reference signal (SRS) to the second terminal through the last symbol of the previously allocated first subframe,
if the second subframe is allocated by a base station by a semi-persistent scheduling (SPS) method, and there is data transmitted through the second subframe, the sounding reference signal is transmitted to the second terminal through the last symbol of the first subframe.

17. The method according to claim 12, wherein, in transmitting the sounding reference signal (SRS) to the second terminal through the last symbol of the previously allocated first subframe,
if the data corresponds to an initial transmission of a HARQ method for direct communication between the first terminal and the second terminal, the sounding reference signal is transmitted to the second terminal through the last symbol of the first subframe.

18. A method, performed by a first terminal, for direct communication between the first terminal and a second terminal, comprising:
mapping data to a previously allocated first subframe;
mapping a sounding reference signal to the last symbol of a first subframe; and
transmitting the first subframe to which the data and the sounding reference signal are mapped to the second terminal.

19. The method according to claim 18, wherein a period of the first subframe is a multiple of the round trip time of HARQ processes for cellular communication.

20. The method according to claim 18, wherein, in mapping a sounding reference signal to the last symbol of a first subframe,
if the data corresponds to an initial transmission of a HARQ method for direct communication between the first terminal and the second terminal, the sounding reference signal is mapped to the last symbol of the first subframe.
